(19) United States
(12) Patent Application Publication
(10) Pub. No.: US 2026/0147971 A1
(43) Pub. Date: May 28, 2026

(54) VERIFICATION TECHNIQUES FOR EMBEDDED SYSTEMS

(71) Applicant: Siemens Electronic Design Automation GmbH, München (DE)

(72) Inventors: Joerg Bormann, Pullach (DE); Raik Brinkmann, München (DE); Dominik Strasser, Gröbenzell (DE)

(21) Appl. No.: 19/122,137

(22) PCT Filed: Dec. 2, 2022
(86) PCT No.: PCT/EP2022/084247

§ 371 Date: Apr. 17, 2025

(51) Int. Cl. G06F 30/3323; G06F 11/3604; G06F 117/08

(52) U.S. Cl. CPC G06F 30/3323; G06F 11/3608; G06F 2117/08

(57) ABSTRACT

A computer-implemented method of verifying an embedded system includes verifying a first firmware component of the embedded system together with a hardware model code of a hardware component of the embedded system, wherein the first firmware component is embedded in a converted code, wherein the converted code is interoperable with the hardware model code provided in a hardware description language.

The present patent document is a § 371 nationalization of PCT Application Serial No. PCT/EP2022/084247, filed Dec. 2, 2022, designating the United States, which is incorporated by reference in its entirety.

### TECHNICAL FIELD

The present disclosure relates to the verification of hardware and firmware of an embedded system.

### BACKGROUND

The process of embedded system design may start with a set of requirements for what the product does and end with a working product that meets all of the requirements. The architecture of the embedded system defines the major blocks and functions of the embedded system such as interfaces, bus structure, hardware functionality, and/or firmware functionality.

Embedded system verification refers to the tools and techniques used to verify that an embedded system does not have hardware or firmware bugs. Firmware (FW) verification aims to execute the software and observe its behavior, while hardware (HW) verification involves making sure the hardware performs correctly in response to outside stimuli. A special challenge in the design and verification of embedded systems is the correct cooperation of firmware and hardware, i.e., the HW/FW co-verification. The challenge arises from different skillsets of the hardware and firmware developers, different tooling, different organizations, and/or different development schedules. Errors in the FW/HW cooperation may be found after time consuming analyses both in the hardware and the software.

The techniques and methodologies of hardware/software co-verification allow projects to be completed in a shorter time and with greater confidence in the hardware and software. HW/SW co-verification may be understood as verifying that embedded system software executes correctly on embedded system hardware. This may include executing the software on the hardware in order to verify that there are no hardware bugs before the design is committed to fabrication.

### SUMMARY

The scope of the present disclosure is defined solely by the appended claims and is not affected to any degree by the statements within this summary. The present embodiments may obviate one or more of the drawbacks or limitations in the related art.

Currently firmware (FW) and hardware (HW) of embedded systems are developed separately, until mostly complete. Only then are they integrated and their integration verified by software tools that involve abstraction or HW accelerators to keep run times tolerable. It even happens that HW and FW are integrated directly on the first silicon samples. The drawback of this approach is that situations where the FW makes wrong usage of the HW, e.g., in case of a FW/HW communication error, appear on system-level, where their analysis is time-consuming, and the retry after correcting the error is bulky. Moreover, this error correction further delays the system test.

It is thus desired to thoroughly verify the firmware and hardware of an embedded system, for example, with respect to syntactically and/or functionally correct behavior. Furthermore, an early verification with respect to the compatibility of the firmware and the hardware of the embedded system is desired. Such compatibility may include errors in the communication between firmware and hardware. An early verification of a firmware component of an embedded system may thus lead to a faster analysis and fix of the firmware component. Thereby, a quicker retry of the verification of the software component is achieved.

According to a first aspect, a computer-implemented method of verifying an embedded system is proposed.

According to a second aspect, a software tool for verifying a hardware model code and a first firmware component according to the first aspect is proposed.

According to a third aspect, a first firmware component of an embedded system is proposed.

According to a fourth aspect, a converted code including the first firmware component is proposed.

According to a fifth aspect, a combined model code including the converted code and the hardware model code of a hardware component of the embedded system is proposed.

According to a sixth aspect, a firmware including one or more first firmware components is proposed.

According to a seventh aspect, an embedded system is proposed.

### BRIEF DESCRIPTION OF THE DRAWINGS

FIG. 1 illustrates an exemplary embedded system.

FIG. 2 illustrates firmware and hardware of an embedded system.

FIG. 3 illustrates firmware and hardware of an embedded system, as well as a combined model code of low-level firmware and hardware model code.

FIG. 4 illustrates another exemplary embedded system, the firmware including firmware components for the respective hardware components of the embedded system.

FIG. 5 illustrates firmware components for the respective hardware components of the embedded system.

FIG. 6 illustrates a first firmware component interacting with a second firmware component and a hardware component.

FIG. 6a illustrates a first firmware component interacting with a second firmware component and a hardware model code.

FIG. 7 illustrates a conversion of a first firmware component into a converted code.

FIG. 8 illustrates a combination of a converted code and a hardware model code into a combined model code.

FIG. 9 illustrates an interaction of a first firmware component embedded in a converted code with a hardware model code.

FIG. 10 illustrates loading of a first firmware component and a converted code, respectively, and a hardware model code into a software tool for verification.

FIG. 11 illustrates a verification of the embedded system on system-level.

FIG. 12 illustrates a host-based simulation for verification of the second firmware component.

### DETAILED DESCRIPTION

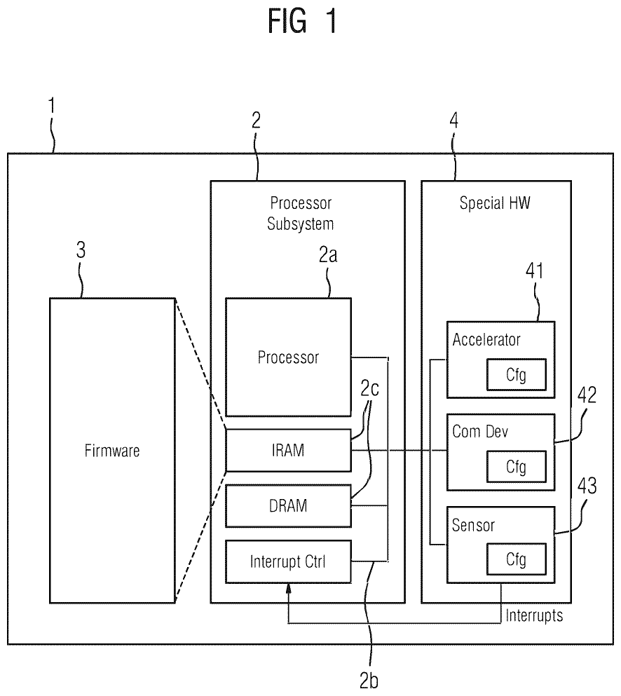

FIG. 1 illustrates an exemplary embedded system 1. An embedded system 1 is a system where functionality is implemented by hardware (HW) and firmware (FW). The partitioning of the functionality into HW and FW may be determined by economic criteria—it is cheaper and more change friendly to implement one or multiple processors 2 in HW and then execute FW there. However, some functionality cannot be realized in FW 3, either because it has high performance requirements or because it needs to interact with the physical world. An example of a hardware component 4, also denoted as special HW in FIG. 1 and throughout the present disclosure, with high performance requirements is an accelerator 41, whereas examples for interaction with the physical world are a communication interface 42 and/or a sensor 43. These hardware components 4 and the firmware 3 determine the special capabilities of the embedded system 1.

In the following, the hardware components 4 are also referred to as special HW and may be distinguished from the processor subsystem 2 of the embedded system 1 that includes the processor 2a, bus 2b, and memory 2c. The memory 2c may include an instruction RAM, IRAM, and/or a data RAM, DRAM, in which the firmware 3 is stored.

The FW 3 configures the special HW 4, distributes data on the special HW 4 and/or collects data from the special HW 4. To that end, the special HW 4 and/or each of the hardware components 41, 42, 43 may include some memory, denoted as Cfg in FIG. 1. Higher FW layers implement software tasks like data management and/or calculations, depending on the functionality of the embedded system 1.

The FW 3 needs to be correct in the sense of self-contained software. The FW 3 may also need to correctly use the special HW 4, i.e., the FW 3 creates supported sequences of transactions, provide supported configuration, and/or parameter values in the correct encoding, make appropriate use of the synchronization mechanisms and/or react correctly on interrupts. Thus, the FW/HW communication is correct if these requirements are satisfied. The correctness of the FW/HW communication is a challenge that is specific to the embedded system and/or to the verification of embedded system.

The functionality of the embedded system 1 is given by the FW 3 and the special HW 4. To fulfill this functionality, the FW 3 and special HW 4 communicates properly. The verification of (the hardware of) the processor subsystem 2 may also be subject to verification. However, in the following the verification, in particular of the interaction, of FW 3 and special HW 4, is discussed herein.

Exemplary FW/HW communication errors include: the FW 3 initiates sequences of accesses that a special HW 4 does not support; the FW 3 is not properly synchronized with the special HW 4; the FW 3 and the special HW 4 disagree about the encoding of (parameter) values read from or written to one or more configuration registers; and the FW 3 writes (parameter) values into a configuration register that are not supported by the special HW 4.

As may be seen in FIG. 1, in the case of a one-piece firmware, errors in FW/HW communication may appear as lately as on system-level, where error analysis and/or error correction are particularly complex. The effort to identify a root cause such FW/HW communication errors on the embedded system appears unnecessarily high, because the search space is large and the visibility into the system is low. Moreover, the special HW 4 of the embedded system is almost frozen then, such that most fixes are FW 3 workarounds, even if they are complicated and thus bear the risk of introduction of further bugs.

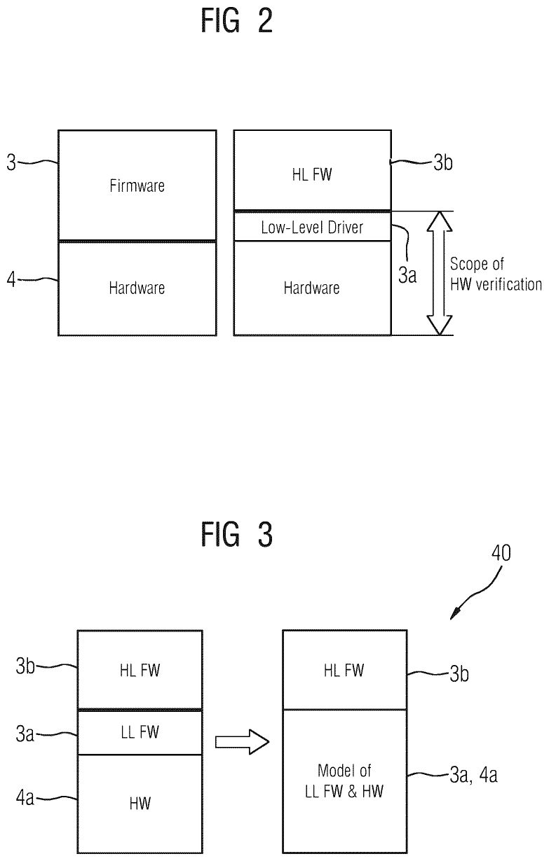

Turning to FIG. 2, firmware 3 and special hardware 4 of an embedded system is illustrated. Therein, the firmware 3 and the special hardware 4 of the embedded system are subject to verification. It is proposed to address the verification of FW/HW communication at an earlier stage, e.g., during the development of the special HW 4. Such special HW 4 may be given in the form of models of one or more hardware components, i.e., in the form of one or more hardware model codes. A hardware model code may be provided in a hardware description language, such as RTL, i.e., at the register transfer level, and may include a few hundred, ten thousand, or even million lines of code. Hence, a verification at system-level, i.e., of the whole embedded system, is not delayed by FW/HW communication errors, e.g., when the verification of the first firmware component and the hardware component already was performed. The proposed solution allows a more efficient analysis of FW/HW communication errors, for example, at an early development stage because of a smaller scope of the analysis and/or verification. Furthermore, changes in the special HW 4 are still an option to efficiently fix FW/HW a communication error.

To reduce the effort related to FW/HW verification, e.g., during the development of an embedded system, it is proposed to develop and/or verify one or more firmware components 3a, such as low-level drivers, for example, given in a programming language, such as C or C++, already during the development of the special hardware 4 of the embedded system. As mentioned, the special hardware 4, i.e., the one or more hardware components, may be modelled by a hardware description language, e.g., at the register-transfer level (RTL). Furthermore, a software tool for verifying the combination of the firmware component 3a and the hardware component 4 (or the hardware model code 4a, respectively) is proposed. Hence, the scope of the verification of the special HW 4 now may not only encompass the special HW 4 but also a first firmware component 3a. Thereby, the development of a FW 3 that interacts properly with the HW 4 is simplified and moves important verification tasks from system-level towards module-level or lower hierarchy levels. Consequently, a higher quality of the verification may be achieved. Further, less verification acts and/or a shorter verification time may be achieved. Still further, bug fix cycles may be shortened and therefore a more efficient verification may be performed.

As mentioned, the first firmware component 3a may be a low-level driver. Thus, the first software component 3a may be close to the special hardware 4. The first firmware component 3a may thus set registers and/or control transmission and/or reception of data, e.g., via a bus system connecting the special hardware 4 with the processor subsystem 2. The remaining part of the FW 3 may be understood as a second firmware component 3b, also referred to as high-level firmware, and invokes the special HW through the low-level drivers 3a. Herein, the terms first firmware component and low-level driver are used interchangeably. The same applies for the second firmware component and the high-level firmware which are used interchangeably herein.

The development and/or verification of the high-level FW 3b is thus simplified, since the interface and/or communication between the low-level drivers 3a and the high-level firmware 3b may be easier to verify, e.g., compared to the low-level access of the special hardware 4. Also, a verification of the low-level driver 3a together with the special HW or the hardware model code 4a increases the quality of the low-level driver 3a. The verification of low-level driver 3a and special HW 4 thus may be executed on module-level, which is quicker and more efficient. A software tool SW that may be used for verification, e.g., hardware-assisted verification, is Veloce. The software tool may be operative to load the low-level driver 3a, in particular without loading a description of the whole processor subsystem 2. Hence, a low-level driver 3a may be associated with each special HW 4 of the embedded system 2. As described, FIG. 2 illustrates a comparison of the verification of a one-piece firmware with a verification of a split firmware, where the low-level driver 3a is verified together with the special hardware 4 or the corresponding hardware model code 4a.

Turning to FIG. 3, an illustration of firmware 3 and a special hardware model code 4a of an embedded system 1 is provided, as well as a combined model code 40 of low-level firmware 3a and hardware model code 4a of a special hardware 4. The first firmware component 3a, also referred to as low-level driver, (LL driver or LL FW), may thus serve for enabling a second firmware component 3b, also referred to as high-level firmware (HL FW) to communicate with a hardware component 4, also referred to a special HW, of the embedded system. To that end, the communication between the firmware 3 and a special HW 4 is isolated in the first firmware component 3a. The verification of the communication may be performed along with and/or separate from the verification of the hardware component 4 or the respective hardware model code 4a. Hence, the verification of the interaction of the first firmware component 3a and the hardware component 4 becomes part of the verification of this hardware component 4. This provides advantages with respect to controllability and/or observability for the verification of the hardware component 4 over the verification of the same hardware component 4 in an integrated system-level verification. From the point of view of the second firmware component 3b, the first firmware component 3a thus hides the communication with the hardware component 4. The first firmware component 3a may only expose an interface to and/or for communication with the second firmware component 3b.

Processor(s), memory, and bus, i.e., the processor subsystem, of the embedded system 1 serve for executing the firmware 3, i.e., the one or more first and second firmware components 3a, 3b. The processor subsystem 2 thus enables the communication of the firmware 3 with the one or more hardware components 4 via bus transactions and/or interrupts. A bus transaction is a sequence of values of the bus signals in successive clock cycles required to perform a read or write operation. A memory or register of the processor subsystem 2 or the hardware component 4 may recognize its address and stores a value from the bus.

Verification of parts of the processor subsystem 2 is well supported by so called electronic design automation tools, EDA tools. For example, Siemens EDA offers a verification tool for processor cores that automates gap-free verification and therefore identifies all bugs in the cores, without demanding particularly deep formal knowledge. Other examples are verification IP for formal and/or simulation-based verification of bus systems, cache verification kits, etc.

However, hardware components 4 of an embedded system 1 are more varied and their verification therefore less standardized and supported by specific verification IP. This is particularly true for the communication between one or more HW components 4 and the respective low-level drivers 31, 32, 33. Although the rules of this communication play a role like a bus protocol, this verification has less support than protocol compliance verification of bus agents. For the purpose of this verification, it is sufficient to abstract the processor subsystem 2 by the sequence of transactions that the first firmware component 3a sends to the hardware component 4. This is given by the semantics of the programming language of the firmware 3.

HW verification, such as formal verification, e.g., by a property checker, may be used to verify the compound functionality of the first firmware component 3a and the hardware model code 4a. Hence, it may be verified whether the first firmware component 3a and the hardware model code 4a are properly complemented by the second firmware component 3b. To that end, for example, for host-based simulation, the results from the verification of the first firmware component 3a and the hardware model code 4a may be used to extend the source code of the first firmware component 3a such that a combined model code 40 is created that contains the compound functionality of the first firmware component 3a and the hardware model code 4a. This combined model code 40 is given, for example, in C or C++. This combined model code 40 may, as the case may be for host-based simulation and/or formal verification, be combined with the second firmware component 3b, e.g., to form one comprehensive executable, that may be executed in order to perform the verification.

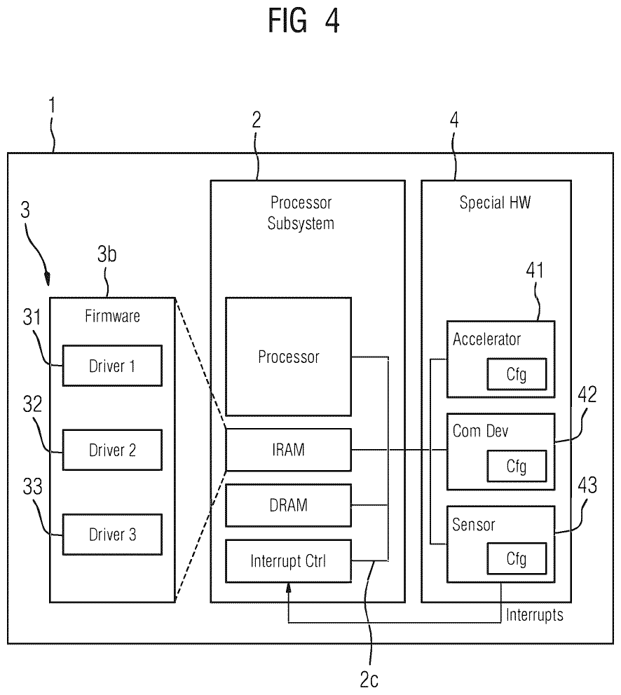

Turning to FIG. 4, another exemplary embedded system 1 including multiple first firmware components 31, 32, 33 for the respective hardware components 41, 42, 43 of the embedded system 1 is illustrated. The firmware 3 may include a plurality of first firmware components 31, 32, 33 that enable the communication of the higher-level firmware 3b with the respective hardware components 41, 42, 43. In other words, the firmware includes a plurality low-level drivers 31, 32, 33, wherein each low-level driver 31, 32, 33 serves for communicating with a respective hardware component. As before, the firmware 3 may be stored in a memory of and may be executed by the processor subsystem.

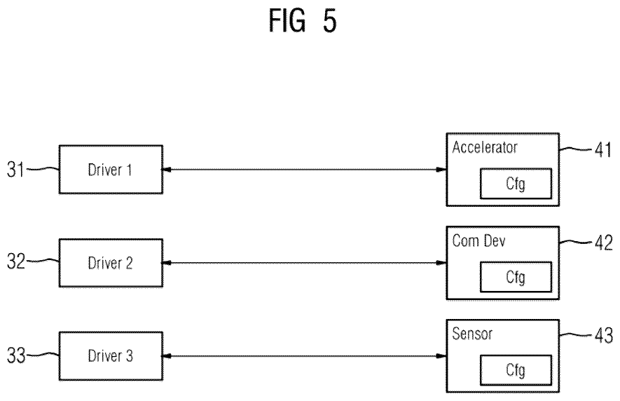

FIG. 5 illustrates a plurality of first firmware components 31, 32, 33 for the respective hardware components 41, 42, 43 of the embedded system. A hardware-firmware co-verification, FW/HW co-verification, may be performed for each pair of a first firmware component 31, 32, 33 and a hardware component 41, 42, 43. As shown in FIG. 5, a first low-level driver 31 is communicatively coupled to the hardware component 41, e.g., when deployed on the embedded system and/or during operation of the embedded system. For the purpose of verification, the hardware component may be modelled by a hardware model code in a hardware description language.

As shown in FIG. 5, a first low-level driver 31 is communicatively coupled to the first hardware component 41, a second low-level driver 32 is communicatively coupled to the second hardware component 42, and the third low-level driver 33 is communicatively coupled to the third hardware component 43. Each low-level driver 31, 32, 33 may be provided in a programming language. For the purpose of verification, the source code of each first firmware component 31, 32, 33 may be embedded in a converted code, e.g., enabling interoperability with a hardware description language. Hence, it is possible to verify the communication between each low-level driver 31, 32, 33, or first firmware component, and the respective hardware component 41, 42, 43 individually. Afterwards the drivers may be communicatively coupled to a second firmware component either for deployment or further verification.

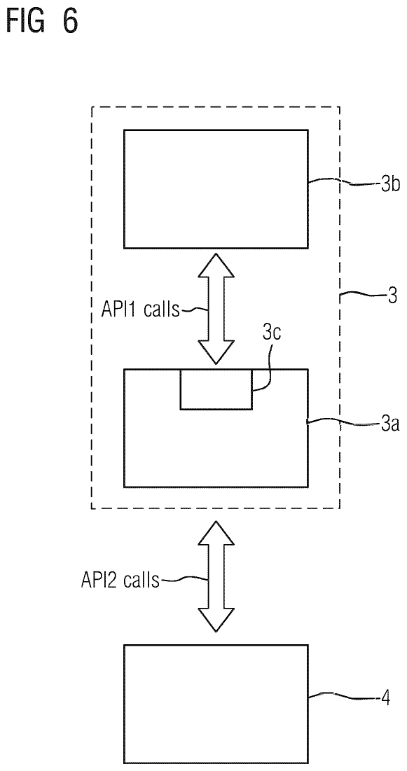

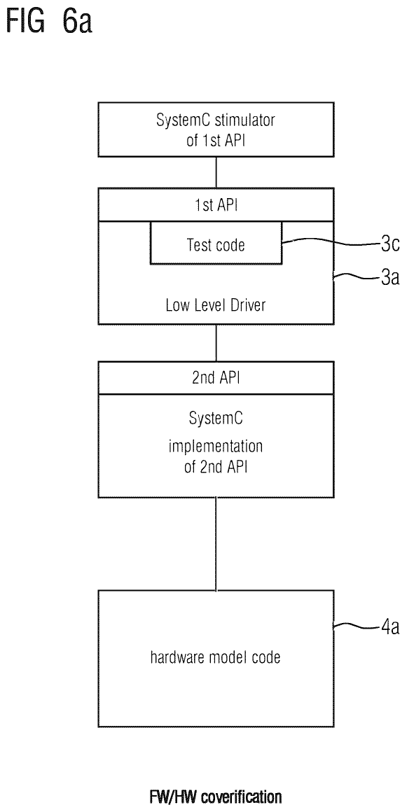

FIG. 6 illustrates a first firmware component 3a interacting with a second firmware component 3b and a hardware component 4. The communication between the first and the second firmware component 3a, 3b, i.e., the low-level-driver and the high-level firmware, may be enabled by a communication interface such as an application programming interface, API. Data exchange and function calls are thus enabled by the API. On the other hand, the communication between the first firmware component 3a and the hardware component 4 may also be enabled by a communication interface, such as an API. Examples to specific API function calls are described herein later on.

In addition, the first firmware component 3a may include a test code component 3c. The test code component 3c may be part of the source code of the first firmware component 3a. Thus, the test code component 3c may be provided in the first programming language, i.e., the programming language the first firmware component is provided in. Thus, the first firmware component 3a includes a test code component 3c. The test code component 3c, e.g., when activated, serves for testing the upper FW layers, i.e., the second firmware component 3b. This test provides that the first firmware component 3a is operated as expected. If not, the test code component 3c causes one or more error message. Since in such a case, the hardware component 4 is configured in an unsupported way, and hence may work unexpectedly. In any case, it is possible to remove the test code component 3c from the first firmware component 3a or to deactivate the test code component 3c.

The test code component 3c of first firmware component may already be used during verification, e.g., pre-silicon testing, for example, of the second firmware component 3b. For example, during pre-silicon validation of the entire firmware and/or during the pre-silicon system-level test, as e.g., shown in FIG. 11, the test code component 3c may be used to check if the second firmware component 3b communicates with the first firmware component 3a as intended. This allows to quickly eradicate FW/HW communication or integration errors, e.g., communication errors that are not prevented by employing the already simpler first API of the first firmware component 3a. Thus, the test code component 3c may issue one or more error messages, if the second firmware component 3b passes unsupported parameter values to the one or more functions of the first firmware component 3a or call one or more functions of the first firmware component 3a in an unsuitable sequence. This prevents the functions of the first firmware component 3a from being called in a way that violates the programming rules of the hardware component.

Turning to FIG. 6a, the test code component 3c of first firmware component may (already) be used for verification (of the interaction or communication) of the first firmware component 3a and the hardware component or the hardware model code 4a. During the development, the test code component 3c may limit the verification to those situations, where the first firmware component 3a is used as intended. For example, during pre-silicon validation of the entire firmware and/or during the pre-silicon system-level test, the test code component 3c may be used to check if the second firmware component 3b communicates with the first firmware component 3a as intended. This allows to quickly eradicate FW/HW communication or integration errors, e.g., communication errors that are not prevented by the already simpler API of the first firmware component 3a. Thus, the test code component 3c may issue one or more error messages, if the second firmware component 3b passes unsupported parameter values to the one or more functions of the first firmware component 3a and/or calls one or more functions of the first firmware component 3a in an unsuitable sequence. This prevents the functions of the first firmware component 3a from being called in a way that violates the programming rules of the hardware component.

Thus, the test code component 3c serves for identifying whether a hardware component is operated incorrectly, i.e., whether the functions of the first firmware component 3a are called by the second firmware component with parameters that lead to unsupported configuration values for the hardware component. Respective tests may be included in the test code component 3c. The test code component 3c may be implemented by one or more asserts, e.g., in C or C++, in the first firmware component and/or functions of the first firmware component. The software tool for verification, e.g., a property checker, may be configured such that it uses these one or more asserts as one or more constraints. Then, the (formal) verification is limited by such one or more constraints. If the proof succeeds, the test code component 3c is found to be sufficiently restrictive. In turn, for example, during simulation of the one or more first firmware components 3a with the second firmware component, an error caused by an assert of a test code component 3c of the one or more first firmware components indicates an error in the second firmware component 3b.

The test code component 3c may be included in the first firmware component 3a. The test code component 3c may be integrated into the first firmware component 3a. The test code component 3c may serve for verification of the higher-level firmware 3b. For example, during the development and/or during verification, the test code component may serve for limiting the verification to those situations, where the first firmware component is used as intended. Additionally, or alternatively, the test code component 3c may be (re-)used to check if the higher-level FW uses the low-level drivers as intended, for example, during pre-silicon validation of the entire FW and pre-silicon system test. This allows to quickly eradicate those FW/HW integration errors that are not prevented by usage of the simpler low-level driver API.

As shown in FIG. 6a stimulator, e.g., a SystemC stimulator, may be used to provide the parameter values to the first firmware component. This stimulator may be part of the software tool for verifying the first firmware component 3a and/or the hardware model code 4a. The stimulator may explore the parameter value space in order to verify the first firmware component 3a and/or the hardware model code 4a. The stimulator may issue one or more so called test vectors including one or more parameter values and/or one or more sequences of parameter values or function calls to the first firmware component. The one or more test vectors may be received by a first API of the converted code. Here, the first firmware component is wrapped into the first API and a second API. The second API being operatively coupled or connected to the hardware model code 4a. Thus, the first and second API form a wrapper in which the first firmware component is embedded. Thereby, it is possible to employ one or more HW verification methods and/or algorithms, e.g., via the stimulator, in order to verify the converter code, including the first firmware component embedded in the wrapper and the hardware model code. Now, the second API may be provided in SystemC in order to operatively couple the first firmware component to the hardware model code. Instead of SystemC, another hardware description language and/or hardware verification language may be used. Thus, methods and apparatus are proposed to enable a FW/HW co-verification of the first firmware component and the hardware component or the hardware model code 4a, respectively.

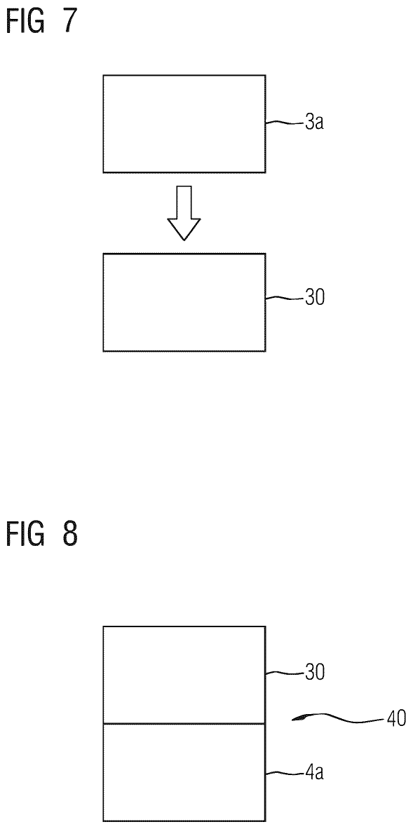

FIG. 7 illustrates a conversion of a first firmware component 3a into a converted code 30. The first firmware component 3a may be provided as a source code in a first programming language. The source code may then be converted or embedded into a converted code 30. The conversion may embed the source code in a hardware description language, e.g., the same or a different hardware description language as the one the hardware code model 4a is in. As explained herein, the first firmware component may be embedded in the converted code. To that end, a wrapper or wrapper code may be used that provides the interoperability of the first firmware component with the hardware model code. The wrapper code may also be operable to obtain hardware verification tasks, e.g., for a software tool for hardware verification. Thus, the converted code is operable to receive input relating to hardware verification, e.g., from a software tool, such as, for example, a property checker for formal verification, for verifying the first firmware component together with the hardware model code.

Subsequently, the first firmware component may thus be in a format, i.e., the converted code, which enables the usage of methods for HW verification, e.g., formal verification and/or as used for verifying the one or more hardware model codes of the one or more hardware components.

FIG. 8 illustrates a combination of a converted code 30 and a hardware model code 4a into a combined model code 40. The converted code 30 may be combined with the hardware model code of a hardware component. The combination may be in the form of a concatenation or may include additional functions for modelling the behavior of the compound functionality of the hardware component and the first firmware component. More specific examples are provided herein.

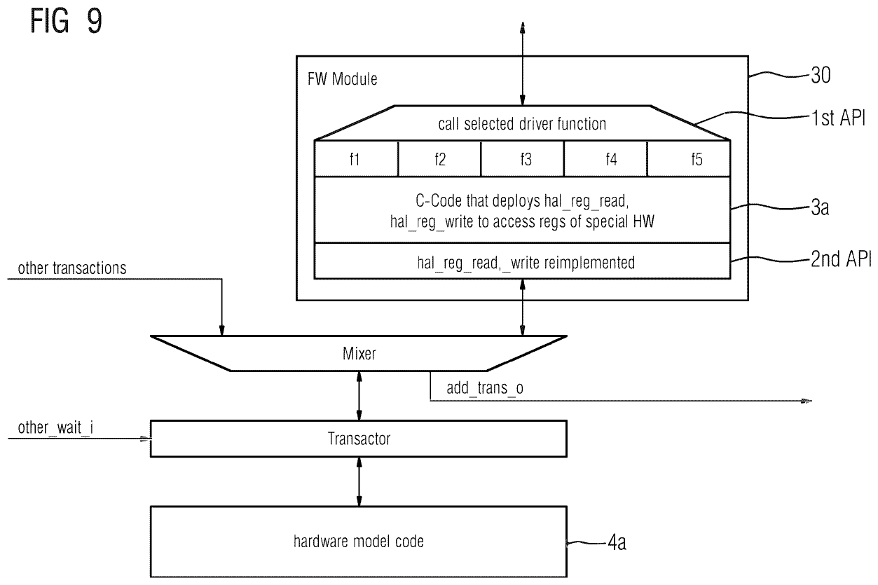

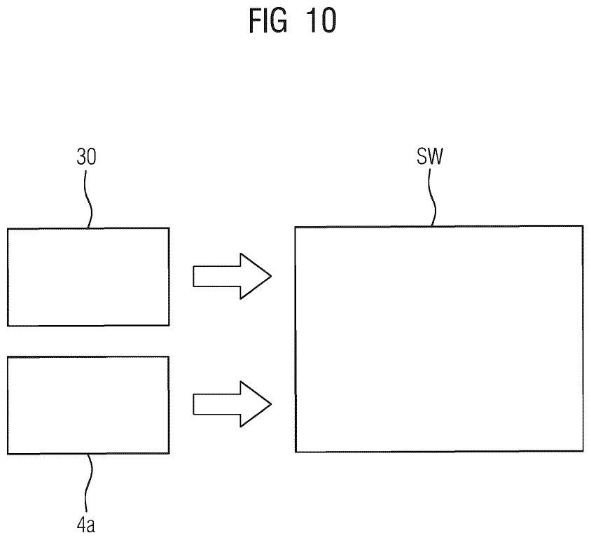

FIG. 9 illustrates an interaction of a first firmware component 3a and with a hardware model code 4a. The first firmware component 3a may be embedded in a, for example, in SystemC, code such that it becomes a synchronous module that is provided with the clock of the hardware component, which is given as a hardware model code 4a. This converted code is denoted as “FW module” in FIG. 9. The introduction of additional signals allows to reuse a property checker to formally verify the interaction of low-level driver and special HW (or hardware model code 4a). To that end, verification tasks or goals are coded in assertions, where conditions about HW signals may be arbitrarily mixed with conditions about the execution of the functions of the low-level driver.

This allows to verify the compound functionality of low-level driver and special HW for a single low-level driver function f1, f2, f3, f4, f5 as well as for sequences of function calls. If multiple calls of functions of the low-level driver are examined, potential effects between the functions of the low-level driver and the higher-level firmware, not shown, may be taken into account. Moreover, effects from multi-threading (i.e., parallel cores or interrupt service routines) may also be included in the verification. Furthermore, the execution of two low-level drivers, e.g., on two parallel processors, that both communicate with the same special HW (or hardware model code 4a) may be verified. The proposed approach allows to limit the verification to a single hardware component (at a time), and thus to manage the complexity of the verification task. The approach is compositional, such that separate verification for each hardware component and its low-level driver is sufficient to provide proper communication between all hardware components modules and their low-level drivers.

The verification may also detect whether the hardware component will not work correctly, if the low-level driver function(s) are called by the high-level FW with parameters that lead to unsupported configuration or parameter values for the hardware component. Respective tests may be incorporated in the test code component, e.g., for verifying the high-level FW. This test code component may be implemented by asserts, for example, in C or C++, as a function of the low-level driver. The property checker, e.g., as described before, may be configured such that it uses these asserts as constraints. Then the formal verification is limited by these constraints. If the proof succeeds, the test code component is found to be sufficiently restrictive. In turn, during simulation of the low-level drivers with the high-level FW an error caused by the test code component's asserts serve for detecting an error in the high-level FW. Thus, a modular verification may be performed that verifies proper FW/HW communication for all firmware components and all hardware components Such modular verifications is faster, more focused, and/or may be configured better. This will speed up the verification and lead to higher quality.

The approach turns the verification task of FW/HW communication into a formal HW-Verification task, such that all achievements of formal hardware verification become applicable also for this verification goal. This includes GapFree verification and its compositional aspects, which allow to verify FW/HW interaction even for complex low-level drivers and large special HW-Modules.

Interrupts in the FW/HW communication verification may be implemented accordingly by including one or more functions of the first firmware component to call interrupt service routines.

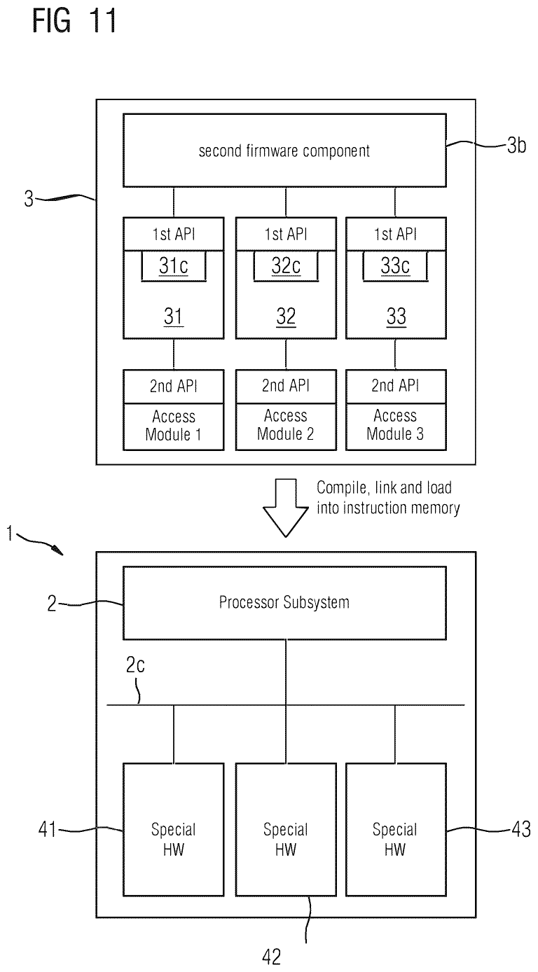

FIG. 10 illustrates loading of a converted code 30 and a hardware model code 4a into a software tool SW for verification. A software tool SW may perform the verification of the first firmware component and the hardware component 4a. The software tool SW may employ formal verification. For example, the property checker OneSpin 360 DV may be used. The software tool SW may receive one or more hardware model codes 4a, e.g., about one or more integrated circuits, assertions with proof goals about the behavior of the signals of the hardware component over time, and/or constraints with assumptions about the behavior of the signals of the model over time as input. The software may also receive the one or more converted codes 30 (including the first firmware component 3a for the respective hardware component code 4a).

For the purpose of verification, one or more assertions and/or constraints may be specified, which do not only refer to the signals of the hardware component but may also include one or more functions calls of the first firmware component 3a. The one or more assertions and/or constraints may also include conditions about a function's parameters, execution times of the function, and/or the return values of the function.

The software tool SW, e.g., the property checker, may prove if the signals of the first firmware component, the converted code, and/or the combined model code satisfy an assertion for verification inputs and/or at all times, whenever the inputs satisfy the constraints. If there is only one execution of the verification input that satisfies the constraints but violates the assertion, the property checker will find it, and may return it as a counterexample. This counterexample is presented in a way that allows a root cause analysis similar to simulation. To specify assertions and constraints, SVA of System Verilog may be used. Siemens Electronic Design Automation offers on top of that the library TIDAL which allows to specify assertions in an easier and more change-friendly way.

The software tool SW, e.g., the property checker, may possess one or more frontends that read integrated circuit descriptions in a hardware description language and translate them into a combined model that is processed by the software tool SW. For example, OneSpin 360 DV has frontends for (System) Verilog, VHDL, EDIF netlists, and SystemC. Integrated Circuit descriptions including parts in different languages are supported, i.e., a mixed language support is provided. Thus, the converted code may be input in a different hardware description language than the hardware model code.

The software tool SW may include a SystemC frontend. This frontend translates SystemC descriptions into a converted code and/or a combined model for the property checker. This allows formal examinations like consistency of SystemC descriptions, e.g., that all array accesses are within bounds; Equivalence checking between high-level synthesis input and output; Validation of high-level synthesis input. The supported subset of SystemC is tailored to the requirements of integrated circuit descriptions. Thus, the SystemC support of the frontend may be used to convert the first firmware component, i.e., the low-level driver, of the firmware into the converted code. Additionally, or alternatively, the converted code 30 may be combined with the hardware model description 4a.

Referring to FIG. 9, an example of a hardware component and first firmware component is provided. The hardware component or the corresponding hardware model code may include an interface to the processor subsystem bus, a conversion module, such as SystemC, with the first firmware component, a (optional) mixer that inserts extra transactions to abstract from the activity of other parts of the embedded system, and an (optional) transactor for the bus protocol, that observes timing variations by other slaves of the bus system.

As described earlier, the first firmware component may be embedded in hardware description language, such as SystemC code, such that it becomes a converted code, which may make the first firmware component a synchronous module that is provided with the clock of the hardware component. The converted code 30 may include an upper and a lower API, also referred to a first API and second API herein. The upper API, i.e., the first API, may expose a number of functions f1, f2, f3, f4, f5 that are called by a second firmware component, not shown, when it wants to use the first firmware component. The lower API may include access functions, such as read_fun(address) and write_fun(address, data), to the configuration registers of the hardware component.

In order to convert the first firmware component 3a into a converted code, the first or upper interface, e.g., in the form of an API, may be created. The first API may be called, for example, by a SystemC process, and may map the signals onto the first firmware component's function calls, for example, as follows:

| Signal | Direction | Semantics |
|---|---|---|
| fw_call_i | input | 0: no function call, i ≠ 0: call of i-th |
| | | driver function |
| par_1_i, | input | parameters during driver function call |
| par_2_i, . . . | | |
| fw_ready_o | output | 0: Driver function is being executed. |
| | | 1: Processor is ready to call a driver |
| | | function. |
| fw_result_o | output | function return value, valid after rising |
| | | edge of fw_ready_o. |

The input/output signals of the first interface will become primary signals of the converted code, also referred to as FW module in FIG. 9. This means that the verification by the software tool, e.g., by a property checker, may explore all signal sequences and combinations unless limited by constraints.

In addition to the first interface, the converted code may include a second interface, i.e., the lower API or lower interface, for transactions that are called by the first firmware component. The signals of the second interface may be mapped as follows:

| Signal | Direction | Semantics |
|---|---|---|
| fw_rd_o | output | Read request |
| fw_wr_o | output | Write request |
| fw_data_o | output | Write data |
| fw_addr_o | output | Address for Reads and Writes |
| fw_addr_i | input | Read data |
| fw_wait_i | input | Delay request by slave during |
| | | transaction execution |
| fw_insert_i | input | Stall FW execution to insert |
| | | extra transactions. |

If fw_insert_i is activated, the first firmware component will terminate the current access and will not issue a request in the next clock cycle (fw_rd_o=0 and fw_wr_o=0). This provides the generalization of the time consumption for the execution of the first firmware component. On top of that, additional transactions may be inserted by the mixer to abstract from the activity of other parts of the embedded system. Fw_insert_i will only be deactivated, when additional transactions terminate. If executing a function of the first firmware component, the module will then request the next transaction.

The protocol may require that rd_o and wr_o are never simultaneously 1. wait_i may only be activated if rd_o or wr_o are active. When wait_i=1, rd_o, wr_o, addr_o and—in case of writes—data_o keeps their values for the next clock cycle. If wait_i=1, then insert_i=0. The reimplementation of write_fun and read_fun by SystemC functions that use the above signals is straightforward. This second or lower interface is connected to the respective mixer interface.

Purpose of the mixer is to insert additional transactions that abstract from other parts of the embedded system. The resultant stream of transactions is passed to the transactor via the interface with the signals tr_rd_o, tr_wr_o, tr_data_o, tr_addr_o, tr_data_i, tr_wait_i. The protocol has been described above. A second interface of the mixer includes the signals fw_rd_i, fw_wr_i, fw_data_i, fw_addr_o, fw_data_i, fw_wait_o, fw_insert_o and is connected to the respective signals of the FW module. A third interface includes the signals r_rd_i, r_wr_i, r_data_i, r_addr_i and determines an extra transaction that is to be inserted after the next clock cycle. The interface is connected to primary inputs of the model, such that the property checker examines the assertions under all values of this interface unless restricted by constraints. The mixer will only read the signal values when fw_wait_o=0. During extra transactions, the mixer provides the protocol, i.e., the freezing of the output values upon tr_wait_i=1. There is an additional signal add_trans_o that determines if the transaction originates from the FW driver or is an extra one.

The transactor receives transactions from the mixer via the interface with the signals tr_rd_i, tr_wr_i, tr_data_i, tr_addr_i, tr_data_o, tr_wait_o. It may turn the transactions into the actual protocol at the bus interface of the special HW module. Moreover, it abstracts from the timing behavior of other slave modules on the bus and influence the bus timing accordingly. In the current example, the slaves use the protocol described above, hence there is no transactor required and its interface to the special HW include the signals hw_rd_o, hw_wr_o, hw_data_o, hw_addr_o, hw_data_i, hw_wait_i. Except for tr_wait_o, these signals connect directly to the interface described first. Only tr_wait_o is calculated by an or gate that combines hw_wait_i with a primary input other_wait_i mimic potential delay by other slaves.

An example of an embedded system including a function for cyclic redundancy check, CRC, is provided. Here, the hardware component may include a CRC generator module. A CRC is used similar to generalized parity bits to avoid that functional faults remain unnoticed. CRC codes may thus contribute to functional safety. The main operation of a CRC generator is to calculate the remainder of a polynomial division of a denominator polynomial by a divisor polynomial. This remainder is the CRC code. The CRC generator has one or more data registers, a divisor polynomial register and/or a seed register. All registers may be accessed via a 32-bit data bus and a 2-bit address bus. The bus protocol also supports the delay of transactions.

An operation of the CRC Generator may first write to the seed register S and to the divisor polynomial register P. Then, data D is written, and the special HW starts the polynomial division as a side effect. The polynomial division takes a few clock cycles. If the result result_o is read before it is calculated, the read access is delayed until the polynomial division is complete.

It is assumed that the environment satisfies two constraints for correct HW operation. Firstly, the seed is shorter than the divisor polynomial. Secondly, the generator receives the divisor polynomial, the seed, and the data in exactly this sequence.

The low-level driver may be provided in a first programming language. This low-level driver may include (only) one function that calls the write transactions to divisor polynomial, seed, and data in the correct sequence and thus satisfies the second HW constraint. Its test code component may check by an assertion, that the seed is indeed shorter than the divisor polynomial. Hence the test code component will create an error message, if the higher-level FW provides parameters that violate the first HW constraint.

The verification of the interaction of low-level driver and hardware component (or hardware model code) by the software tool then enables a quick stabilization of the low-level driver through quick edit-verify-analysis cycles.

The low-level driver may include a function crc_call(p, s, d). The type of all function parameters and the return value is a 32 bit unsigned integer, e.g., in accordance with the data bus size of the processor.

A software tool may verify the compound functionality of low-level driver and hardware component code. The verification may use formal methods. To map the problem on the well-known formal HW assertion checks, the low-level driver may be wrapped, for example, by SystemC, in constructs, i.e., code. These constructs may additionally introduce auxiliary signals beyond the hardware signals. These auxiliary signals may control the low-level driver functions. For example:

| Signal | Direction | Semantics |
|---|---|---|
| fw_call_i | input | 1: invoke crd_call; 0: no functional call |
| par_1_i, | input | Parameters of the function call |
| par_2_i, . . . | | |
| fw_ready_o | output | 0: function is being executed, 1: ready to |
| | | call the function |
| fw_result_o | output | Return value of crc_call, valid after rising |
| | | edge of fw_ready_o |

The software tool may be capable of handling different hardware description languages. In addition, the software tool may allow to merge different HW description languages. Hence, the low-level driver (e.g., in the converted code) may be loaded together with the special hardware, i.e., the corresponding hardware description code. Thereby, assertions about the joint activity of the low-level driver and the special hardware may be made. An exemplary System Verilog property and/or assertion to check of the compound function of low-level driver and HW is may be:

```
property drv_sva;
  logic [31:0] d;
  logic [31:0] s;
  logic [31:0] p;
```

| | |
|---|---|
| ##1 | (fw_ready_o && fw_call_i == 2′b01 && // invokes crc_call |
| | crc_in_idle, |
| | p = par_1_i, |
| | s = par_2_i, |
| | d = par_3_i, |
| ##1 | !fw_ready_o[*20] |
| ##1 | fw_ready_o |

|−>

fw_result_o == crc(p, s, d);

endproperty
drv_sva_p: assert property (disable iff (!rst_n_i) drv_sva).

The assertion uses local SVA variables to store the parameter values for the calculation of a reference for the return value. The assertion validates low-level driver and special HW, i.e., the hardware component, for every value combination, for example, every-value combination that is not rejected by the test code component. Any deviation between calculated and actual value may be uncovered quickly with a counter example, i.e., a simulation trace that allows to efficiently analyze the problem.

It is thus proposed to extend the verification of a special HW to encompass a low-level driver. Thereby, difficulties around the signal interface of the HW may be mitigated. The converted code or the combined code allows for a thorough verification of these comparatively small objects. Thus, complications of the signal interface are hidden by the low-level driver and/or the corresponding API to the higher-level firmware. This application programming interface API may be simpler. This may reduce the communication issues between FW and HW at the time when the whole system is assembled, such that the system level verification of the embedded system may start earlier and is less disturbed by FW/HW communication bugs than today.

FIG. 11 illustrates a system-level verification of the embedded system 1. The firmware 3 includes a second firmware component 3b and a plurality of first firmware components 31, 32, 33. Each first firmware component is specific to a hardware component and enables communication with that hardware component. As already explained, each first firmware component 31, 32, 33 has a first and a second API. The first API exposes a number of functions that are called by the second firmware component, when it wants to use the special HW. The second API includes the access functions, such as read_fun(address) and write_fun(address, data) to the configuration registers of the special HW. By compiling, linking and/or loading the firmware 3 into a memory of the processor subsystem, the embedded system including the actual hardware components 4a, 4b, 4c may be made operative and/or may be verified.

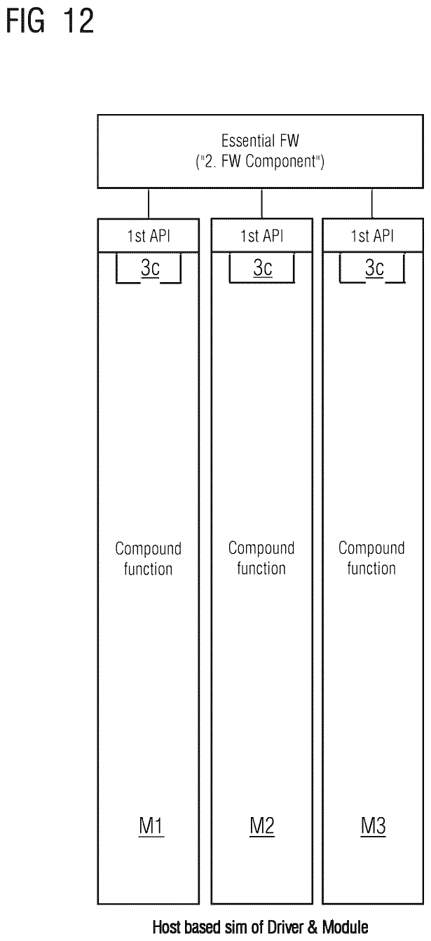

FIG. 12 illustrates a host-based simulation for verification of the firmware and hardware. For verifying the second firmware component, a host-based simulation may be performed. To that end, the compound functionality of the first firmware component and the hardware model code may be reused or newly modelled. The host-based simulation may make use of a simulation model that is derived from the first firmware component and/or a verification code of the combined functionality of the first firmware component and the hardware component. The behavior of the second firmware model may then be verified by the communication between the simulation model and the second firmware component. As shown in FIG. 12, there may a separate simulation model for each combination of first firmware component and the associated hardware component. That is to say, a 1.first firmware component and a first hardware component are model by a first simulation model M1, a 2.first firmware component and a second hardware component are modelled by a second simulation model M2, and/or a 3.first firmware component and a third hardware component are model by a third simulation model M3. The simulations model may also include the test code component 3c functionalities as described herein. The simulation models M1, M2, M3 may be accessible via the first API, that as described before, communicatively couples the first firmware component to the second firmware component. Again, the first API in the example provided in FIG. 12 may differ from each other, since these API provide access to the different 1., 2., and/or 3. first firmware components.

A verification may be performed by a host-based simulation. Thereby a verification of the entire system function, including higher-level FW and the special HW, and additionally the processor subsystem may be performed. Host-based simulation requires the reimplementation of the driver functions, such that all HW transactions are removed. Instead, parts of the end-to-end assertions about the compound functionality would be used to calculate the read data of these transactions. For example, the code of crc_call may be modified, such that it does no longer create transactions to the hardware, but instead uses a C/C++ version of the crc function from the assertion to calculate the return value. If all special HW modules of an embedded system have such drivers, and all drivers are modified accordingly, a self-contained software is created, that features the whole embedded system functionality and allows verifying the FW.

The fast and therefore attractive FW and system verification method of host-based simulation abstracts from the FW/HW communication and therefore may not support its verification at all. For host-based simulation, the functions of a suitably lowly chosen FW-API may be reimplemented such that they represent the compound functionality of these functions and the special HW.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method of verifying an embedded system, the method comprising:
verifying a first firmware component of the embedded system together with a hardware model code of a hardware component of the embedded system,
wherein the first firmware component is embedded in a converted code, and
wherein the converted code is interoperable with the hardware model code provided in a hardware description language.

2. The method of claim 1, further comprising:
obtaining the converted code comprising a source code of the first firmware component, wherein the source code is provided in a first programming language; and
obtaining the hardware model code of the hardware component in the hardware description language.

3. The method of claim 1, wherein the converted code comprises a source code of the first firmware component embedded in a wrapper code in a same hardware description language or a different hardware description language as the hardware model code.

4. The method of claim 1, wherein the converted code receives input relating to hardware verification from a property checker for formal verification for verifying the first firmware component together with the hardware model code.

5. The method of claim 1, wherein the first firmware component enables communication between a second firmware component and the hardware component of the embedded system.

6. The method of claim 1, further comprising:
combining the converted code and the hardware model code into a combined model code; and
verifying the first firmware component with the combined model code.

7. The method of claim 1, wherein the first firmware component comprises a first interface for communication with a second firmware component, and/or
wherein the first firmware component comprises a second interface, for controlling and/or reading electrical signals for communication with the hardware component.

8. The method of claim 1, wherein the embedded system further comprises a processor, a memory, and/or a bus for executing the first firmware component and/or a second firmware component.

9. The method of claim 1, wherein the verifying of the first firmware component comprises verification of the hardware model code, the first firmware component, the converted code and/or a combined model code comprising the hardware model code and the converted code by a software tool, and
wherein the software tool applies functional verification, of a communication between the first firmware component and the hardware component for verifying encoding, one or more sequences of communication, synchronization, and/or interrupt calls when using the hardware component.

10. The method of claim 1,
receiving, by a software tool, a source code, the converted code, and/or the hardware model code; and
performing a property check on a combined model code comprising the hardware model code and the converted code.

11. The method of claim 1, wherein the embedded system comprises a plurality of hardware components and a plurality of first firmware components,
wherein a respective first firmware component is provided for each hardware component of the plurality of hardware components,
wherein each first firmware component of the plurality of first firmware components serves for communicating with the respective hardware component of the plurality of hardware components,
wherein each hardware component is represented by a corresponding hardware model code in the hardware description language, and
wherein each first firmware component is embedded in a respective converted code and each respective converted code is combined with the corresponding hardware model code and verified.

12. The method of claim 1, wherein the hardware component is part of an integrated circuit and comprises one or more logic elements and/or one or more transistors.

13. The method of claim 1, further comprising:
verifying the first firmware component, a second firmware component, and/or the hardware model code the of the embedded system in an integration test and/or a system test.

14. The method of claim 1, wherein the verifying of the first firmware component comprises verifying whether a combination of the first firmware component and a second firmware component causes an error message contained in the first firmware component.

15. The method of claim 1, wherein the verifying comprises verifying the embedded system by a host-based simulation of a second firmware component, and
wherein the first firmware component is replaced by a host-based simulation model derived from the first firmware component and/or a verification code of a combined functionality of the first firmware component and the hardware component.

16. The method of claim 1, further comprising:
verifying a combined model code comprising the converted code and the hardware model code before performing an integration test and/or a system test.

17. The method of claim 5, wherein the second firmware component is configured to perform a first set of calculations and communicate resulting parameter values to the hardware component and/or the hardware model code as a result of the first set of calculations.

18. The method of claim 1, wherein the first firmware component comprises a test code component that causes an error message when a second firmware component communicates unsupported parameter values to the first firmware component, parameter values in an unsuitable order, and/or during an unsuitable state of the first firmware component and/or the hardware component or the hardware model code.

19. The method of claim 1, wherein the first firmware component comprises a test code component that limits the verifying to an expected range and/or configurable range and/or sequence of parameter values to be obtained from a second firmware component.

20. The method of claim 9, wherein the verifying of the combined model code comprises setting, based on a second firmware component, one or more assertions and/or constraints for verifying the combined model code, and
wherein the one or more assertions and/or constraints comprises a behavior of the combined model code over time.

21.-24. (canceled)

25. A firmware comprising:
one or more first firmware components of an embedded system for communicating with one or more hardware components associated with the one or more first firmware components and for communicating with a second firmware component,
wherein each first firmware component of the one or more first firmware components comprises a first interface for communicating with the second firmware component of the embedded system and a second interface for communicating with the hardware component of the embedded system,
wherein the embedded system is configured to verify each first firmware component together with a hardware model code of a respective hardware component of the one or more hardware components,
wherein each first firmware component is embedded in a converted code, and
wherein the converted code is interoperable with the hardware model code provided in a hardware description language.

26. (canceled)

27. An embedded system comprising:
a firmware having one or more first firmware components, at least one second firmware component, and one or more hardware components,
wherein each first firmware component of the one or more first firmware components comprises a first interface for communicating with the second firmware component of the embedded system and a second interface for communicating with the hardware component of the embedded system,
wherein the embedded system is configured to verify each first firmware component together with a hardware model code of a respective hardware component of the one or more hardware components,
wherein each first firmware component is embedded in a converted code, and wherein the converted code is interoperable with the hardware model code provided in a hardware description language.
